(19) United States
(12) Patent Application Publication
(10) Pub. No.: US 2022/0203736 A1
(43) Pub. Date: Jun. 30, 2022

(54) MEDIA MODIFICATION MARKS BASED ON IMAGE CONTENT

(71) Applicant: Hewlett-Paqckard Development Company, L.P., Spring, TX (US)

(72) Inventors: Shaun Patrick Henry, Boise, ID (US); Gregory Doyle Creager, Boise, ID (US); Jonathan Keith Neuneker, Boise, ID (US)

(73) Assignee: Hewlett-Packard Development Company, L.P., Spring, TX (US)

(21) Appl. No.: 17/616,721

(22) PCT Filed: Sep. 20, 2019
(86) PCT No.: PCT/US2019/052193

§ 371 Date: Dec. 6, 2021

(51) Int. Cl. B41J 29/393; G06T 7/13; G06T 7/50; G06K 15/10; G06K 15/02

(52) U.S. Cl. CPC B41J 29/393; G06T 7/13; G06T 7/50; B31D 5/04; G06K 15/1852; G06K 15/1885; G06K 15/102

(57) ABSTRACT

Examples of generating media modification marks based on image content are described. In some examples, modification marks for converting a two-dimensional (2D) media to a three-dimensional (3D) shape are generated based on image processing of an image. In some examples, the modification marks are applied to the 2D media.

### BACKGROUND

Computing devices may perform image processing on digital images. Printing devices may print images on a print media. For instance, a printing device may process the print media to change the appearance of the print media. In some examples, the printing device may apply a print substance to the print media. In other examples, the printing device may cause changes (e.g., structural or chemical changes) within the print media.

### BRIEF DESCRIPTION OF THE DRAWINGS

Various examples will be described below by referring to the following figures.

FIG. 1 is a block diagram of an example of a computing device that may generate modification marks for a two-dimensional (2D) media based on image content;

FIG. 2 is a block diagram of an example of a printing device that may generate modification marks for a 2D media based on image content;

FIGS. 3A-3C illustrate an example of generating modification marks for an image;

FIG. 4 is a flow diagram illustrating an example of a method for generating modification marks for a 2D media based on image content; and

FIG. 5 is a flow diagram illustrating another example of a method for generating modification marks for a 2D media based on image content.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations in accordance with the description; however, the description is not limited to the examples and/or implementations provided in the drawings.

### DETAILED DESCRIPTION

The techniques described herein relate to generating media modification marks based on image content. As used herein a “modification mark” is information that may be applied to two-dimensional (2D) media to indicate a modification of the 2D media. In some examples, the modification marks may be generated by a computing device, which causes a separate printing device to apply the modification marks. In other examples, a printing device generates and applies the modification marks.

A printing device may apply a print substance to a print media. Examples of printing devices include printers, copiers, fax machines, multifunction devices including additional scanning, copying, and finishing functions, all-in-one devices, pad printers to print images on three dimensional objects, and three-dimensional printers (additive manufacturing devices).

In some examples, the print substance may include printing agents or colorants. The printing device may apply the print substance to a substrate. A substrate is a superset of print media, such as plain paper, and can include any suitable object or materials to which a print substance from a printing device is applied including materials, such as powdered build materials, for forming three-dimensional articles. In addition, in some examples, a printing device may print on various media such as inanimate objects, skin, books, wood, plastic, metal, concrete, wallpaper, or other materials. Print substances, including printing agents and colorants, are a superset of inks and can include toner, liquid inks, or other suitable marking material that may or may not be mixed with fusing agents, detailing agents, or other materials and can be applied to the substrate.

In other examples, the printing device may be a fluid ejection device. For example, the printing device may be used in bio-printing, printed manufacturing features and sensors for additive manufacturing applications. These applications may use a print substance other than ink or toner.

In some examples, a printing device—including thermal printers, piezoelectric printers, computer numerical control (CNC) machines (e.g., CNC laser, CNC waterjet, CNC router, etc.)—may modify the structure of the print media to create an image (e.g., text or graphic image). In other examples, a printing device—including printers, copiers, fax machines, multifunction devices including additional scanning, copying, and finishing functions, all-in-one devices, and pad printers to print images on three dimensional objects—may apply a print substance, which can include printing agents or colorants, to a print media.

In some examples, the printing device may be a small (e.g., handheld) imaging and printing device. In some examples, these printing devices may be used in a form of physical social-media between friends and loved ones to both share and make memories.

The examples of printing devices and computing devices described herein may dynamically apply modification marks to a print media. In some examples, the modification marks may be a fold mark, a cut mark or other mark indicating a physical modification of the print media. The modification marks may be generated based on the content of an image. The modification marks may be used to create exciting and creative 3D shapes to enhance a 2D image.

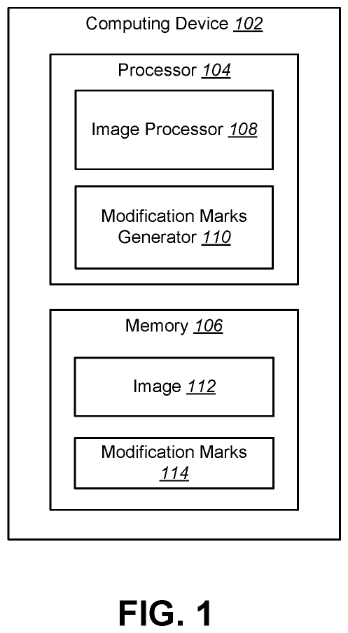

FIG. 1 is a block diagram of an example of a computing device 102 that may generate modification marks 114 for a two-dimensional (2D) media based on image content. The computing device 102 may be an electronic device, such as a printing device, personal computer, a server computer, a smartphone, a tablet computer, camera, game console, etc.

The computing device 102 may include and/or may be coupled to a processor 104 and/or a memory 106. In some examples, the computing device 102 may include a display and/or an input/output interface. In some examples, the computing device 102 may be in communication with (e.g., coupled to, have a communication link with) an external device (e.g., smartphone, personal computer, a server computer, a smartphone, a tablet computer, camera, game console, etc.). The computing device 102 may include additional components (not shown) and/or some of the components described herein may be removed and/or modified without departing from the scope of this disclosure.

The processor 104 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 106. The processor 104 may fetch, decode, and/or execute instructions (e.g., instructions to implement an image processor 108 and/or modification marks generator 110) stored in the memory 106. In some examples, the processor 104 may include an electronic circuit or circuits that include electronic components for performing a function or functions of the instructions (e.g., instructions to implement the image processor 108 and/or modification marks generator 110). In some examples, the processor 104 may perform one, some, or all of the functions, operations, elements, methods, etc., described in connection with one, some, or all of FIGS. 1-5.

The memory 106 may be any electronic, magnetic, optical, or other physical storage device that contains or stores electronic information (e.g., instructions and/or data). The memory 106 may be, for example, Random Access Memory (RAM), Electrically Erasable Programmable Read-Only Memory (EEPROM), a storage device, an optical disc, and the like. In some examples, the memory 106 may be volatile and/or non-volatile memory, such as Dynamic Random Access Memory (DRAM), EEPROM, magnetoresistive random-access memory (MRAM), phase change RAM (PCRAM), memristor, flash memory, and the like. In some implementations, the memory 106 may be a non-transitory tangible machine-readable storage medium, where the term “non-transitory” does not encompass transitory propagating signals. In some examples, the memory 106 may include multiple devices (e.g., a RAM card and a solid-state drive (SSD)).

In some examples, the computing device 102 may include an input/output interface through which the processor 104 may communicate with an external device or devices (not shown), for instance, to receive and store information (e.g., an image 112). The input/output interface may include hardware and/or machine-readable instructions to enable the processor 104 to communicate with the external device or devices. The input/output interface may enable a wired or wireless connection to the external device or devices (e.g., personal computer, a server computer, a smartphone, a tablet computer, etc.). The input/output interface may further include a network interface card and/or may also include hardware and/or machine-readable instructions to enable the processor 104 to communicate with various input and/or output devices, such as a keyboard, a mouse, a display, a touchscreen, a microphone, a controller, another apparatus, electronic device, computing device, etc., through which a user may input instructions into the computing device 102.

The computing device 102 may receive an image 112. In some examples, the computing device 102 may include a camera (not shown) that captures the image 112. In other examples, the computing device 102 may receive the image 112 from an external source. For example, the image 112 may be captured by an external camera and transferred to the computing device 102. The computing device 102 may store the image 112 in memory 106.

The processor 104 may implement an image processor 108 to perform image processing on the image 112. The image processor 108 may determine content of the image 112 through the image processing. In some examples, the image processing may include edge detection. For example, the image processor 108 may perform Canny edge detection on the image 112 to determine boundaries (i.e., edges) within the image 112. Canny edge detection may be used to extract useful structural information from different vision objects within the image 112. Canny edge detection may dramatically reduce the amount of data to be processed.

It should be noted that other edge detection techniques may be used in addition to the Canny technique. For example, the image processor 108 may perform edge detection using Sobel, Prewitt, Roberts, and/or fuzzy logic methods in addition to, or instead of, the Canny method.

In other examples, the image processor 108 may perform image processing other than edge detection to identify content of the image 112. For example, the image processor 108 may perform object recognition to identify objects within the image 112. In another example, the image processor 108 may perform facial recognition to identify faces or features of faces within the image 112. It should be noted that the image processor 108 may perform a combination of image processing techniques. For example, the image processor 108 may perform object recognition and edge detection and to identify edges for certain objects while ignoring other objects.

In some examples, the image processing may be based on the location of an object within the image 112. For example, the image processor 108 may perform edge detection on objects in the foreground of the image 112, while objects in the background are ignored (i.e., no edge detection may be performed on background objects).

In some examples, the image processing may be based on the focus of objects and/or regions in the image. Objects or regions of the image 112 that are within a threshold focus may be processed by the image processor 108 while objects or regions of the image 112 that are outside the threshold focus may not be processed.

In some examples, the processor 104 may present the image 112 to a user to select objects or regions for image processing. For example, the processor 104 may cause the image 112 to be displayed. A user may then select certain object(s) or region(s) of the image 112 for image processing. The image processor 108 may perform the image processing (e.g., edge detection, object recognition, etc.) based on the user selection.

The processor 104 may implement a modification marks generator 110 to generate modification marks 114 for converting a two-dimensional (2D) media to a three-dimensional (3D) shape based on the image processing of the image 112. The modification marks 114 may be stored in memory 106.

In some examples, the modification marks 114 may include cut marks to indicate where the 2D media is to be cut to form the 3D shape. In other examples, the modification marks 114 may include fold marks to indicate where the 2D media is to be folded to form the 3D shape. In another example, the modification marks 114 may include a combination of cut marks and fold marks to form the 3D shape.

In yet other examples, the modification marks 114 may indicate other operations to modify the 2D media to create the 3D shape. For example, the modification marks 114 may indicate gluing, stapling, ripping, punching, burning or other modification techniques.

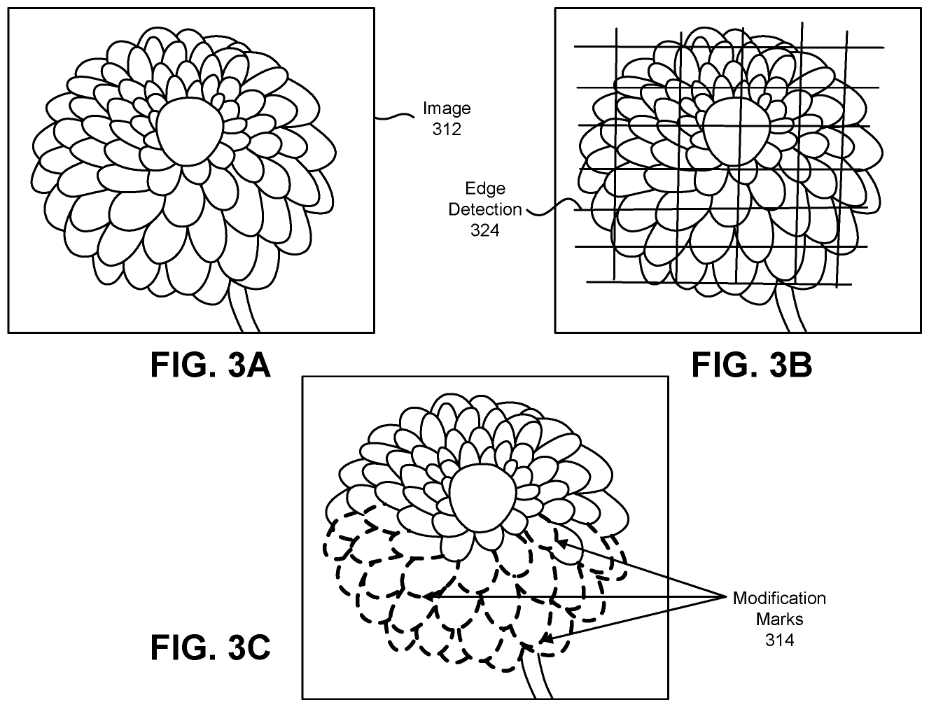

In some examples, the modification marks generator 110 may determine the 3D shape based on the image processing. In other words, the modification marks 114 may be generated in consideration of the final 3D shape. For example, a 3D shape for the image 112 may be selected using the results of the edge detection. In an example where the image 112 includes a mountain, the 3D shape may include the contour of the mountain. In an example where the image 112 includes a person, the 3D shape may include the outline of the person or part (e.g., face, arm, leg, etc.) of the person. In another example, the 3D shape for the image 112 may be selected based on object recognition or facial recognition. In an example where the image 112 includes a flower, the 3D shape may include cutouts of flower petals. An example of a 3D shape of a flower is described in FIGS. 3A-3C.

In some examples, the 3D shape may be a pre-configured shape that is modified based on the image processing. For example, the computing device 102 may include a number of pre-configured 3D shapes that may be used to modify the image 112. A 3D shape may be selected and modified (e.g., adjusted, scaled, cropped, etc.) based on the content of the image identified through image processing.

In some examples, the computing device 102 may present a list of 3D shape options to a user. In this case, the user may select a 3D shape. Upon receiving the 3D shape selection, the computing device 102 may generate the modification marks 114 to create the 3D shape based on the results of the image processing (e.g., edge detection). In some examples, pre-designed modification marks 114 may be stored in the computing device 102. The pre-designed modification marks 114 may be selectively applied to the image 112 by the user. There may be various 3D shapes that the user can select and manipulate. Once selected, the modification marks 114 may be generated based on the results of the image processing.

In some examples, the computing device 102 may store pre-designed modification marks 114 that are an official and/or authorized version. For example, an organization, business or entity may issue official and/or authorized versions of modification marks 114. These official and/or authorized versions of the modification marks 114 may be communicated to the computing device 102. In some examples, these official and/or authorized versions of the modification marks 114 may be purchased and/or downloaded from an internet-based marketplace.

In some examples, the modification marks generator 110 may generate the modification marks 114 based on the selected 3D shape. For example, the modification marks 114 may follow a subset of the edges identified in the image 112 such that once the 2D media is modified according to the modification marks 114, the 2D media will have the selected 3D shape.

In some examples, the modification marks generator 110 may generate the modification marks 114 using a machine learning model. For example, the computing device 102 may include a machine learning model that creates modification marks 114 for an image 112 matching certain criteria. For example, the pose of subjects (e.g., people) in the image 112 may be provided to the machine learning model to create modification marks 114 to create a 3D shape based on the pose.

In some examples, the machine learning model may be updated to improve the performance of the modification marks generator 110. For example, user feedback may be used to improve the results of the machine learning model used by the modification marks generator 110. An updated machine learning model for the modification marks generator 110 may be communicated to the computing device 102.

In some examples, the modification marks 114 may be presented to the user. For example, the modification marks 114 may be displayed on a display (not shown) associated with the computing device 102. In some examples, the modification marks 114 may be overlaid on the image 112 to indicate how the image 112 is to be modified.

In some examples, the computing device 102 may receive user adjustments of the modification marks 114. For example, a user may change the modification marks 114 that are generated by the modification marks generator 110. In some examples, the user may delete and/or add modification marks 114. In other examples, the user may move and/or rotate one or multiple modification marks 114. For instance, the user may shift the modification mark(s) 114 a certain distance from an edge in the image 112. In other examples, the user may change the shape and/or size of the modification marks 114. In yet other examples, the user may change the type of the modification mark(s) 114. For instance, the user may change a cut line to a fold line.

In some examples, the computing device 102 may track the user adjustments to generate the modification marks 114. For instance, the computing device 102 may learn user preferences and/or behavior for the modification marks 114 based on prior user adjustments of prior modification marks. In other words, the computing device 102 may determine how a user changes the modification marks 114 that the computing device 102 dynamically generates. The computing device 102 may then take the past user adjustments into consideration when generating the modification marks 114. In an example, if a user consistently moves the modification marks 114 to a certain distance beyond edges in the image 112, the computing device 102 may save this adjustment as a user preference. The computing device 102 may then automatically shift the modification marks 114 based on this user preference on subsequent images 112.

In some examples, the user adjustment tracking may be implemented as a machine learning model. For example, the computing device 102 may generate and/or update a machine learning model based on user adjustments to the generated modification marks 114.

In some examples, the modification marks 114 may be generated based on user feedback of prior modification marks 114. For example, once the computing device 102 generates modification marks 114 for the image 112, a user may rate the quality of the modification marks 114. For instance, the user may assign a value (e.g., 1 through 10) to the modification marks 114. The computing device 102 may use the user feedback to adjust the generation of subsequent modification marks 114. In this manner, the computing device 102 may refine the quality of the modification marks 114.

In some examples, the user feedback may be communicated to a cloud service, which may aggregate user feedback from multiple users and/or multiple computing devices 102. The modification marks generator 110 may be updated based on the aggregated user feedback.

In some examples, the modification marks 114 are to be applied to the 2D media. For example, the modification marks 114 may be lines (e.g., solid lines, dotted lines, dashed lines, etc.) printed on the 2D media. In some cases, the modification marks 114 may be printed with the image 112. In one approach, the modification marks 114 may be printed overlaid on the image 112. In this approach, the modification marks 114 may follow the edges of the image content. In another approach, the modification marks 114 may be printed on a back side of the image 112 opposite the image 112. In yet another approach, the modification marks 114 may be applied (e.g., printed) to the 2D media without reproducing the image 112 on the 2D media.

In other examples, the modification marks 114 may be generated as instructions (e.g., G-code) to modify the 2D media. For instance, the modification marks 114 may be applied to a 2D media using CNC techniques (e.g., laser cutter, CNC router, waterjet, etc.) using G-code or other CNC instructions.

In some examples, instructions to create the 3D shape using the modification marks 114 may be printed on the back side of the 2D media. For example, the instructions may tell a user how to cut and/or fold along the modification marks 114. For complex shapes, the printed instructions may provide a sequence for how to cut and/or fold along the modification marks 114 to create the 3D shape.

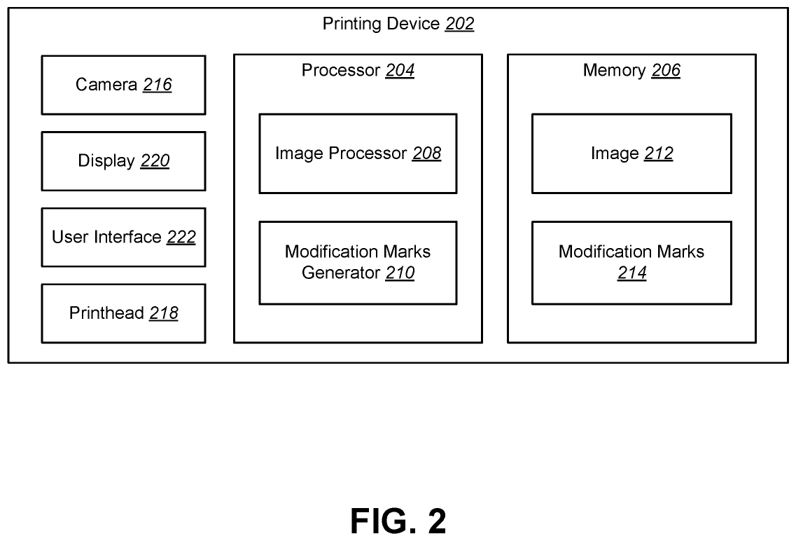

FIG. 2 is a block diagram of an example of a printing device 202 that may generate modification marks 214 for a two-dimensional (2D) media based on image content. In some examples, the printing device 202 may be an imaging and printing device. For example, the printing device 202 may include a camera 216 to capture an image 212. The printing device 202 may also include a printhead 218 to print on a 2D media.

The printing device 202 may include a processor 204 and memory 206, which may be implemented in accordance with the processor 104 and memory 106 described in FIG. 1. For example, the processor 204 may implement an image processor 208 to perform image processing of the image 212. The processor 204 may also implement a modification marks generator 210 to generate modification marks 214 for converting a 2D media to a 3D shape based on the image processing (e.g., edge detection, object recognition, etc.).

In some examples, the printing device 202 may include a display 220 to display the modification marks 214 overlaid on the image 212. In this manner, the user may observe how the modification marks 214 are to be printed.

In some examples, the printing device 202 may include a user interface 222 to receive user adjustments of the modification marks 214. For example, the user may adjust the modification marks 214 presented in the display 220 by using the user interface 222. Some examples of the user interface 222 include physical components (e.g., touchscreen, touchpad, button(s), slider, mouse, etc.) and/or virtual components (e.g., a graphical user interface presented on the display 220).

Upon generating the modification marks 214, the printing device 202 may use the printhead 218 to print the modification marks 214 and the image 212 on the 2D media. In one approach, the modification marks 214 may be printed overlaid on the image 212. In another approach, the modification marks 214 may be printed on a back side of the image 212.

FIGS. 3A-3C illustrate an example of generating modification marks 314 for an image 312. The modification marks 314 may be generated by a computing device 102 or printing device 202 as described in FIG. 1 and FIG. 2.

In this example, the original image 312 shown in FIG. 3A includes a flower. In FIG. 3B, edge detection 324 is being performed to identify contours within the image 312 of the flower. In this case, the contours follow the petals of the flower. FIG. 3C shows modification marks 314 generated from the edge detection 324.

In this example, the modification marks 314 are depicted as dashed lines on the image 312. In this case, the modification marks 314 are cut lines where a user is to cut the printed image. The user may adjust the modification marks 314 before the image 312 and modification marks 314 are printed.

The modification marks 314 may be printed overlaid with the image 312. Upon cutting the printed image, the user may fold the cut portions of the image 312 to convert the 2D flower into a 3D shape.

It should be noted that, in some examples, the modification marks 314 may be created, filtered and/or modified in a number of ways. In some examples, the computing device 102 and/or printing device 202 may generate modification marks 314 for all or a subset of edges identified by the edge detection 324. A user may then select which modification marks 314 to keep, delete and/or modify. For example, a user may select the edges on which to apply modification marks 314. In another example, a user may define a minimum and/or maximum distance between edges. In yet another example, a user may switch a cut mark to a fold mark.

In other examples, image recognition may be used to determine which edges in the image 312 will receive modification marks 314. In some examples, the computing device 102 and/or printing device 202 may determine what the object is in the image 312 (e.g., a person, an animal, a flower, etc.) using image recognition processes. The computing device 102 and/or printing device 202 may then generate the modification marks 314 based on the edge detection 324 and the image recognition.

In the example of flower in FIGS. 3A-3C, the computing device 102 and/or printing device 202 may use image recognition to determine that a flower is in the image 312. The computing device 102 and/or printing device 202 may then use orientation checking to determine where the “bottom” of the image 312 is. The computing device 102 and/or printing device 202 may then make the modification marks 314 (e.g., cut marks and/or fold marks) that accentuate the image 312 by being cut so that the bottom petals are folded outwards towards the viewer. In this way, when a viewer is looking at the image 312 from slightly above, a more three-dimensional presentation is provided.

In some examples, focal point analysis may be used to generate and select modification marks 314. For example, for images where the subject is not decipherable by image recognition, the computing device 102 and/or printing device 202 may use focal point analysis to find what the user was focusing on when the image 312 was taken. Then the computing device 102 and/or printing device 202 may accentuate the image 312 by providing modification marks 314 (e.g., fold marks and/or cut marks) on edges outward from there.

In addition to image recognition to determine the selection and orientation of the modification marks 314, other approaches may be used to generate modification marks 314. For example, edges of a certain thickness, direction or curvature may be identified as edges that will be augmented with modification marks 314. In another example, edges within a certain color, hue and/or contrast range may be augmented with modification marks 314. In another example, edges within a certain region or multiple regions of the image 312 may be augmented with modification marks 314. In yet another example, a certain number of edges within the image 312 as a whole or within a certain proximity range to each other or within a given region (or regions) may be augmented with modification marks 314. It should be noted that these approaches serve as examples of how modification marks 314 may be generated, selected and/or modified, and should not be interpreted as a restrictive list of limited applications.

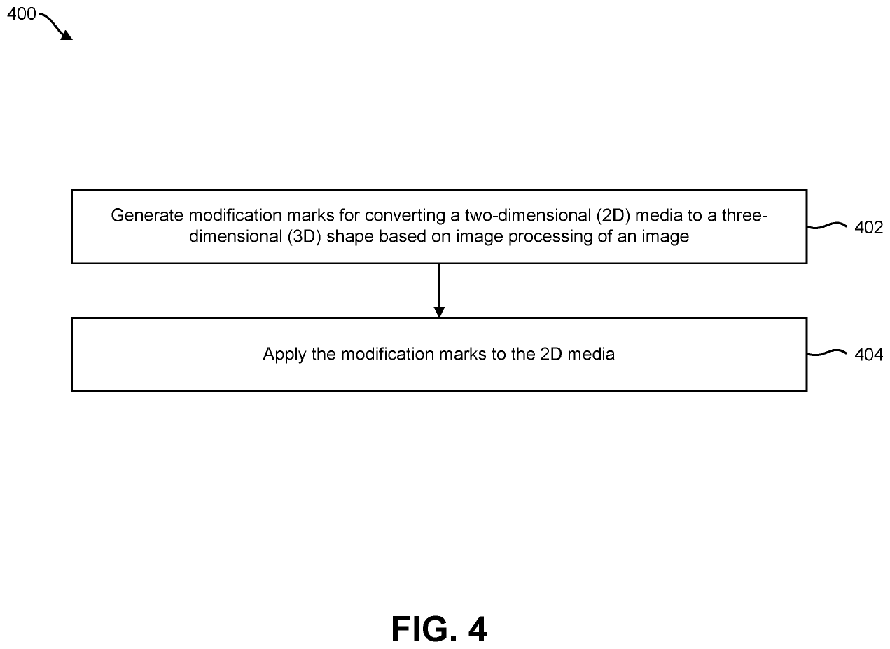

FIG. 4 is a flow diagram illustrating an example of a method 400 for generating modification marks 114 for a 2D media based on image content. The method 400 for may be performed by, for example, the processor 104 of the computing device 102 of FIG. 1 or the processor 204 of the printing device 202 of FIG. 2. It should be noted that for ease of explanation, the method 400 is described in terms of the processor 104 of FIG. 1.

The processor 104 may generate 402 modification marks 114 for converting a 2D media to a 3D shape based on image processing of an image 112. For example, a computing device 102 may receive and/or capture a digital image 112. In some examples, the processor 104 may perform edge detection (e.g., Canny edge detection, among others) on the image 112. The processor 104 may determine the 3D shape of the image 112 based on the edge detection. The processor 104 may generate the modification marks 114 based on the edge detection and the 3D shape.

In some examples, the modification marks 114 may include cut marks to indicate where the 2D media is to be cut to form the 3D shape. In other examples, the modification marks 114 may include fold marks to indicate where the 2D media is to be folded to form the 3D shape. In yet other examples, the modification marks 114 may include a combination of cut marks and fold marks to form the 3D shape.

The processor 104 may apply 404 the modification marks 114 to the 2D media. For example, the processor 104 may cause the modification marks 114 to be printed with the image 112. In some examples, the modification marks 114 may be printed overlaid on the image 112. In other examples, the modification marks 114 may be printed on a back side of the 2D media opposite the image 112.

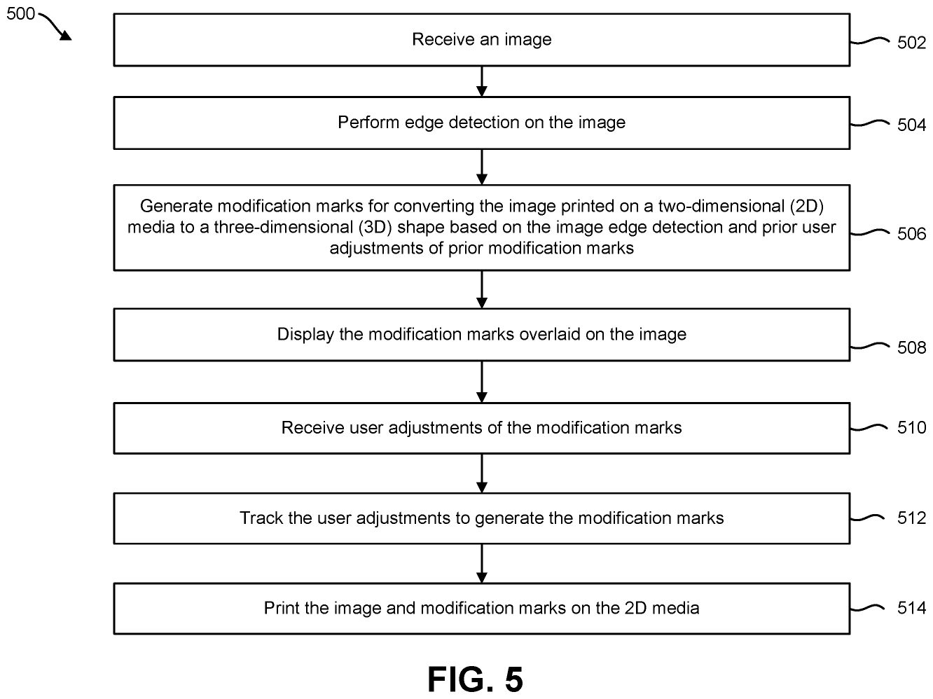

FIG. 5 is a flow diagram illustrating another example of a method 500 for generating modification marks 114 for a 2D media based on image content. The method 500 for may be performed by, for example, processor 204 of the printing device 202 of FIG. 2. It should be noted that for ease of explanation, the method 500 is described in terms of the printing device 202 of FIG. 2. However, the method 500 may also be implemented by the computing device 102 of FIG. 1.

The processor 204 may receive 502 an image 212. For example, the printing device 202 may include a camera 216 that captures the image 212, which is sent to the processor 204.

The processor 204 may perform 504 edge detection on the image 212. For example, the processor 204 may perform 504 Canny edge detection to identify contours in the image content.

The processor 204 may generate 506 modification marks 214 for converting the image 212 printed on a 2D media to a 3D shape based on the image edge detection and prior user adjustments of prior modification marks. For example, the printing device 202 may store prior user adjustments of modification marks 214. The processor 204 may determine user preferences from the prior user adjustments. The processor 204 may generate 506 the modification marks 214 based on the edge detection. The processor 204 may then adjust the modification marks 214 based on the user preferences determined from the prior user adjustments.

The processor 204 may display 508 the modification marks 214 overlaid on the image 212. For example, the processor 204 may cause a display 220 of the printing device 202 to display the modification marks 214 on top of the image 212. In some examples, the modification marks 214 may be rendered as lines or curves.

The processor 204 may receive 510 user adjustments of the modification marks 214. For example, the printing device 202 may include a user interface 222 in communication with the processor 204. A user may adjust the displayed modification marks 214 using the user interface 222. The processor 204 may adjust the modification marks 214 based on the user adjustments.

The processor 204 may track 512 the user adjustments to generate the modification marks 214. For example, tracking the user adjustments may include determining user preferences for the modification marks 214 based on prior user adjustments of prior modification marks. Tracking the user adjustments may also include storing current user adjustments of the current modification marks 214 to determine user preferences for subsequent modification mark generation.

The processor 204 may print 514 the image 212 and the modification marks 214 on the 2D media. For example, the processor 204 may send instructions to the printhead 218 of the printing device 202 to print the image 212 and the modification marks 214. In some examples, the modification marks 214 may be printed overlaid on the image 212. In other examples, the modification marks 214 may be printed on a back side of the 2D media opposite the image 212.

It should be noted that while various examples of systems and methods are described herein, the disclosure should not be limited to the examples. Variations of the examples described herein may be implemented within the scope of the disclosure. For example, functions, aspects, or elements of the examples described herein may be omitted or combined.

1. A method, comprising:
generating modification marks for converting a two-dimensional (2D) media to a three-dimensional (3D) shape based on image processing of an image; and
applying the modification marks to the 2D media.

2. The method of claim 1, wherein the modification marks comprise cut marks to indicate where the 2D media is to be cut to form the 3D shape.

3. The method of claim 1, wherein the modification marks comprise fold marks to indicate where the 2D media is to be folded to form the 3D shape.

4. The method of claim 1, wherein the modification marks comprise a combination of cut marks and fold marks to form the 3D shape.

5. The method of claim 1, wherein generating the modification marks comprises:
performing edge detection on the image;
determining the 3D shape based on the edge detection; and
generating the modification marks based on the edge detection and the 3D shape.

6. The method of claim 1, further comprising displaying the modification marks overlaid on the image.

7. A computing device, comprising:
a memory; and
a processor coupled to the memory, wherein the processor is to:
receive an image;
perform edge detection on the image; and
generate modification marks for converting the image printed on a two-dimensional (2D) media to a three-dimensional (3D) shape based on the image edge detection.

8. The computing device of claim 7, wherein the processor is to receive user adjustments of the modification marks.

9. The computing device of claim 8, wherein the processor is to track the user adjustments to generate the modification marks.

10. The computing device of claim 9, wherein tracking the user adjustments comprises determining user preferences for the modification marks based on prior user adjustments of prior modification marks.

11. The computing device of claim 7, further comprising generating the modification marks based further on user feedback of prior modification marks.

12. A printing device, comprising:
a camera to capture an image;
a memory to store the image;
a processor coupled to the memory, the processor is to:
perform image processing of the image; and
generate modification marks for converting a two-dimensional (2D) media to a three-dimensional (3D) shape based on the image processing; and
a printhead to print the modification marks and the image on the 2D media.

13. The printing device of claim 12, wherein the printing device is to print instructions to create the 3D shape using the modification marks on a back side of the 2D media.

14. The printing device of claim 12, further comprising a display to display the modification marks overlaid on the image.

15. The printing device of claim 12, further comprising a user interface to receive user adjustments of the modification marks.
